(19) United States
(12) Patent Application Publication
(10) Pub. No.: US 2026/0108806 A1
(43) Pub. Date: Apr. 23, 2026

(54) Systems and Methods for Processing External Communications in Video Game

(71) Applicant: Sony Interactive Entertainment Inc., Tokyo (JP)

(72) Inventors: Victoria Dorn, San Mateo, CA (US); Andres Aceves, Harvey, IL (US); Sankalp Mohanty, San Mateo, CA (US)

(21) Appl. No.: 18/919,012

(22) Filed: Oct. 17, 2024

(51) Int. Cl. A63F 13/31; A63F 13/65; A63F 13/87

(52) U.S. Cl. CPC A63F 13/31; A63F 13/65; A63F 13/87

(57) ABSTRACT

A communication is received from a source external to a video game. The received communication is processed through a first artificial intelligence (AI) engine to determine a manner and a timing for conveyance of the received communication to a player of the video game who is currently playing the video game. A second AI engine is executed to implement a non-player character within the video game for conveyance of the received communication. The received communication is conveyed through the non-player character to the player of the video game in accordance with the manner and the timing as determined by the first AI engine. The first AI engine is also executed to collectively process multiple received communications to identify redundant communications and to generate a consolidated communication for conveyance to the player of the video game in lieu of the redundant communications.

### BACKGROUND OF THE INVENTION

The video game industry has seen many changes over the years and has been trying to find ways to enhance the video game play experience for players and increase player engagement with the video games and/or online gaming systems, which ultimately leads to increased revenue for the video game developers and providers and the video game industry in general. Video game developers have also been seeking improvement in video game production and time-to-market, which serves to improve retention of player interest and correspondingly increase revenue. It is within this context that implementations of the present disclosure arise.

### SUMMARY OF THE INVENTION

In an example embodiment, a system for processing external communications in a video game is disclosed. The system includes a computer processor configured to receive a communication from a source external to a video game. The system also includes a computer memory configured to store the received communication. The system also includes a first artificial intelligence (AI) engine configured to process the received communication stored in the computer memory to determine a manner and a timing for conveyance of the received communication to a player of the video game who is currently playing the video game. The system also includes a second AI engine configured to implement a non-player character within the video game through which the received communication is conveyed. The computer processor configured to direct conveyance of the received communication to the player of the video game by way of the non-player character in accordance with the manner and the timing as determined by the first AI engine.

In an example embodiment, a method is disclosed for processing external communications in a video game. The method includes receiving a communication from a source external to a video game. The method also includes processing the received communication through a first AI engine to determine a manner and a timing for conveyance of the received communication to a player of the video game who is currently playing the video game. The method also includes executing a second AI engine to implement a non-player character within the video game for conveyance of the received communication. The method also includes conveying the received communication through the non-player character to the player of the video game in accordance with the manner and the timing as determined by the first AI engine.

### BRIEF DESCRIPTION OF THE DRAWINGS

FIG. 1 shows various components of an example server device within a cloud-based computing system that provides a video game for play by a player at a client device, in accordance with some embodiments.

FIG. 2 shows an example of the second AI engine implementing a non-player character that already exists within the context of the player's play of the video game in order to convey a received/consolidated communication to the player, in accordance with some embodiments.

FIG. 3 shows an example of the second AI engine implementing a non-player character that already exists within the context of the player's play of the video game in order to convey a received/consolidated communication to the player, in accordance with some embodiments.

FIG. 4 shows another example of the second AI engine implementing a non-player character that does not already exist within the context of the player's play of the video game in order to convey a received/consolidated communication to the player, in accordance with some embodiments.

FIG. 5A shows a flowchart of a method for processing external communications in a video game, in accordance with some embodiments.

FIG. 5B shows a more detailed flowchart of the operation 503 of the method of FIG. 5A for processing external communications in the video game, in accordance with some embodiments.

FIG. 5C shows a more detailed flowchart of the operation 505 of the method of FIG. 5A for processing external communications in the video game, in accordance with some embodiments.

FIG. 6 shows a flowchart of a method for processing external communications in a video game, in accordance with some embodiments.

### DETAILED DESCRIPTION OF THE INVENTION

In the following description, numerous specific details are set forth in order to provide a thorough understanding of the present disclosure. It will be apparent, however, to one skilled in the art that embodiments of the present disclosure may be practiced without some or all of these specific details. In other instances, well known process operations have not been described in detail in order not to unnecessarily obscure the present disclosure.

Many modern computer applications, such as video games, virtual reality applications, augmented reality applications, virtual world applications, etc., include generation and output of video and associated audio. For ease of description, the term “video game” as used herein refers to any type of computer application in which video and associated audio is output to reflect interactive engagement of a user with the computer application, such as by way of providing video game controller inputs. The user of the video game is a player of the video game and/or a spectator of the video game play. In various embodiments, the player of the video game corresponds to a character shown within the video of the video game. Also, in various embodiments, the video game is defined to enable the player of the video game to control the action, appearance, and essentially any other feature of the character within the video game that corresponds to the player of the video game. Also, in various embodiments, the video game is defined to enable the player of the video game to control various aspects of the video game context, such as scenes, views, in-game objects, sounds, communications, among essentially any other feature within the video game for which player control is appropriate.

A video game developer is a real-world person that engages in developing the video game and/or the associated video and audio output of the video game. The developer of the video game is often challenged to create video and associated audio within the video game that engages and entertains players of the video game in accordance with various development objectives. In various embodiments, the development objectives can include providing visual variety, providing entertaining and engaging audio, promoting visual interest, attracting attention, conveying meaning, provoking emotion, inviting contemplation, stimulating user interaction with the video game, ensuring achievable player advancement within the video game, and ensuring sufficient player challenge within the video game, among many other development objectives. The video game may include various scenes, stages, and/or branches through which the player of the video game moves or progresses, with each having associated video and audio output. The video game development process expends extensive financial and temporal resources on creating these various scenes, stages, and/or branches of the video game and their associated video and audio output.

When a player is engrossed in playing of a video game, the player may not be able to hear external communications that are not generated as part of playing of the video game. External communications as used herein refers to any type of communication, whether it be audible, textual, image-based, or of another form, that is communicated to a player of a video game from an external communication source that is not actively involved in playing of the video game. In some embodiments, the external communication source is a spectator of the video game. In some embodiments, the external communication source is a real-world person from whom a communication is conveyed to the real-world person who is the player of the video game. In some embodiments, the external source has no association with the video game. In some embodiments, the subject/content of the external communication is relevant to the play of the video game. In some embodiments, the subject/content of the external communication is not relevant to the play of the video game. In some embodiments, the subject/content of the external communication concerns an issue within a real-world context associated with the real-world person who is the player of the video game.

As video games get bigger and include larger numbers of players and spectators, there are more people trying to communicate at the same time with a given player. This creates too much noise for the player and becomes increasingly distracting to the player, which can adversely affect the player's engagement with the video game. Additionally, as the number of external communication sources increases, the likelihood of having redundant communications increases, which can in turn lead to a waste of computing resources that are required to process the redundant communications. Also, as the number of external communication sources increases, more important communications, such as those from real-world persons that are not associated with the video game play, can get overshadowed by the noise associated with the large number of external communications and may be missed by the player of the video game. Also, while it is often generally beneficial for the player of the video game to receive external communications during play of the video game, it may not be beneficial for the player of the video game to receive external communications at certain critical times during their play of the video game. In consideration of the foregoing, it is of interest to develop methods and systems to process external communication in a video game, so that external communications that are directed to a player of the video game can be received, processed, and delivered to the player in a manner that is minimally disruptive to the player's play of the video game and simultaneously attentive to the relevancy and importance of the content of the external communications. Various embodiments are disclosed herein in which external communications are captured, buffered, and overlaid and/or inserted into an audio/video stream corresponding to play of a video game that is transmitted and presented to a player of the video game.

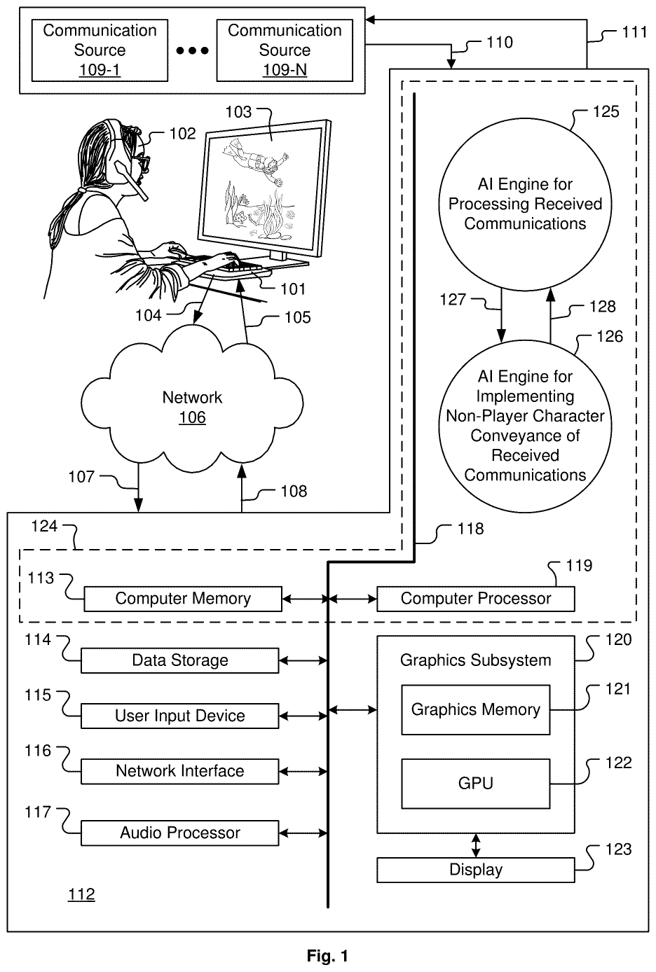

FIG. 1 shows various components of an example server device 112 within a cloud-based computing system that provides a video game for play by a player 102 at a client device 101, in accordance with some embodiments. In various embodiments, the server device 112 incorporates or is implemented as a personal computer, video game console, personal digital assistant, a head mounted display (HMD), a wearable computing device, a laptop or desktop computing device, a server or any other digital computing device, suitable for practicing an embodiment of the disclosure. The server device 112 includes a computer processor 119, e.g., central processing unit (CPU), for running software applications and optionally an operating system. In various embodiments, the computer processor 119 includes one or more homogeneous or heterogeneous processing cores. For example, in some embodiments, the computer processor 119 is one or more general-purpose microprocessors having one or more processing cores. In some embodiments, the computer processor 119 is implemented using one or more CPUs with microprocessor architectures specifically adapted for highly parallel and computationally intensive applications, such as processing operations of interpreting a query, identifying contextually relevant resources, processing multiple incoming communications, and implementing and rendering the contextually relevant resources in a video game immediately.

The server device 112 includes a computer memory 113 configured to store applications and data for use by the computer processor 119. The server device 112 also includes a data storage 114 configured to provide non-volatile data storage and to provide storage of other computer readable media for applications and data. In various embodiments, the data storage 114 includes fixed disk drives, removable disk drives, flash memory devices, and CD-ROM, DVD-ROM, Blu-ray, HD-DVD, and/or other optical storage devices, as well as signal transmission and storage media. In some embodiments, the server device 112 includes one or more user input devices 115 configured to communicate user inputs from one or more users to the server device 112. It should be understood that the user input devices 115 are located at the physical locations of the users/players that access the services/video games that are provided by the server device 112. In various embodiments, the user input devices 115 include one or more of keyboards, mice, joysticks, touch pads, touch screens, still or video recorders/cameras, tracking devices for recognizing gestures, and/or microphones. The server device 112 also includes a network interface 116 that is configured to enable the server device 112 to engage in bidirectional data communication with other computer systems via an electronic communications network 106, which in various embodiments includes wired and/or wireless data communication over local area networks and/or wide area networks such as the Internet. In some embodiments, the server device 112 includes an audio processor 117 configured to generate analog and/or digital audio output from instructions and/or data provided by the computer processor 119, the computer memory 113, and/or the data storage 114. In some embodiments, the various components of server device 112, including the computer processor 110, the computer memory 113, the data storage 114, the user input devices 115, the network interface 116, and the audio processor 117 are connected by one or more data bus(es) 118.

In some embodiments, the server device 112 includes a graphics subsystem 120 in data communication with the data bus 118 and with the various other components of the server device 112. In some embodiments, the graphics subsystem 120 includes a graphics processing unit (GPU) 122 and a graphics memory 121. In some embodiments, the graphics memory 121 includes a display memory (e.g., a frame buffer) used for storing pixel data for each pixel of an output image. In various embodiments, the graphics memory 121 is integrated in the same device as the GPU 122, is connected as a separate device relative to the GPU 122, and/or is implemented within computer memory 113. In some embodiments, pixel data is provided to the graphics memory 121 directly from the computer processor 119. Alternatively, in some embodiments, the computer processor 119 provides the GPU 122 with data and/or instructions defining the desired output images of the video game, from which the GPU 122 generates the pixel data of one or more output images of the video game. The data and/or instructions defining the desired output images of the video game are stored in the computer memory 113 and/or in the graphics memory 121. In some embodiments, the GPU 122 includes three-dimensional (3D) rendering capabilities for generating pixel data for output images of the video game from instructions and data defining the geometry, lighting, shading, texturing, motion, and/or camera parameters for virtual object(s) within a context/scene of the video game. In some embodiments, the GPU 122 further includes one or more programmable execution units capable of executing shader programs. In some embodiments, the graphics subsystem 120 periodically outputs pixel data for an image from the graphics memory 121 to be displayed on display device 123.

The server device 112 is in bidirectional data communication through the network 106 with the client device 101 of the player 102 of the video game that is provided by the server device 112, as indicated by arrows 104, 105, 107, and 108. The client device 101 includes a display device 103 on which a video stream of the video game is displayed to the player 102 of the video game. In various embodiments, the display device 103 is any device capable of displaying visual information in response to a signal from the server device 112, including CRT, LCD, plasma, OLED, and/or QLED displays, among any other type of display device. In various embodiments, the server device 112 provide the client device 101 with analog and/or digital signals to enable display of the video stream of the video game on the display device 103 for viewing by the player 102 of the video game. Also, in various embodiments, the server device 112 conveys an audio stream to the player 102 of the video game. In some embodiments, the audio stream is provided in conjunction with the video stream of the video game. In various embodiments, the audio stream includes audio associated with play of the video game by the player 102. Also, in various embodiments, the audio stream includes audio associated with external communications that are received and processed by the server device 112 from one or more communication sources 109-1 to 109-N that are external (separate) from both the server device 112 and the player 102 of the video game. In some embodiments, the server device 112 is in bidirectional communication (audio, digital data, and/or optical data communication) with each of the one or more communication sources 109-1 to 109-N, as indicated by arrows 110 and 111.

The server device 112 implements a system 124 for processing external communications in a video game. The system 124 includes the computer processor 119 configured to receive a communication from any one or more of the communication sources 109-1 to 109-N external to the video game, where N is an integer number greater than zero. The system 124 also includes the computer memory 113 configured to store the received communication. The system 124 also includes a first artificial intelligence (AI) engine 125 that is configured to process the received communication stored in the computer memory 113 to determine a manner and a timing for conveyance of the received communication to the player 102 of the video game who is currently playing the video game. In some embodiments, in determining the manner for conveyance of the received communication to the player 102 of the video game who is currently playing the video game, the first AI engine 125 functions to do one or more of minimizing player 102 distraction caused by the communication conveyance, reducing redundancy across multiple communication conveyances, and abbreviating/compressing extended/verbose communications before conveyance.

The first AI engine 125 is configured to process game play state data of the video game that is continuously and dynamically generated by the video game. The game play state data of the video game is input to the first AI engine 125 and is analyzed by the first AI engine 125 to support implementation of the system 124. The game play state data of the video game defines the state and/or condition of the video game at a particular point during play of the video game by one or more players, e.g., player 102. In this manner, the game play state data provides a snapshot of the video game play at a particular time. In some embodiments, the game play state data of the video game defines the state of game play of the player 102 of the video game at a particular point in time. In some embodiments, the game play state data of the video game includes user/player saved data that includes information that personalizes the video game for the particular player 102. For example, the game play state data of the video game can include information associated with the particular player's 102 character, so that the video game is rendered with a character that may be unique to the particular player 102 at the particular point in the video game play, such as with regard to shape, look, clothing, weaponry, etc. In various embodiments, the game play state data of the video game includes game characters, game objects, game object attributes, game attributes, game object state, graphic overlays, among any other data necessary to recreate the state of the video game at the particular point in time. The game play state data provides for regeneration of the gaming environment within the video game that existed at the particular point in time corresponding to the game play state data. In various embodiments, the game play state data of the video game also includes the state of every device used for rendering the output of the video game, such as the states of the computer processor 119, the graphics processing unit 122, the computer memory 113, the computer register values, the program counter value, the programmable direct memory access (DMA) state, the buffered data for the DMA, the audio processor 117 chip state, the computer readable medium state, and/or any other device involved in generating the output of the video game. Also, in various embodiments, the game play state data of the video game identifies which parts of the executable code of the video game need to be loaded to execute the video game from the point in the video game corresponding to the game play state data. In some embodiments, the game play state data of the video game is input to the first AI engine 125 in accordance with a prescribed processing schedule to optimize use of computational resources for implementing the communication optimization methods disclosed herein.

In some embodiments, the first AI engine 125 is configured process the game play state data to perform a contextual analysis of the current play of the video game by the player 102. Also, in some embodiments, the first AI engine 125 is configured to process historical game play state data associated with the player 102 and/or with other players to determine how the player 102 and/or other players play the video game. In some embodiments, the first AI engine 125 is configured to predict, in real-time, actions that will be taken by the player 102 during the player's 102 current play of the video game. Also, in some embodiments, the first AI engine 125 is configured to predict, in real-time, actions and/or events within the context of the video game that are relevant to the player's 102 current status within the video game. In this manner, the first AI engine 125 is able to determine which aspects/features of the video game are currently present to and/or associated with the player 102 of the video game.

The communications that are received from the external communication sources 109-1 to 109-N, as indicated by arrow 110, are provided as input to the first AI engine 125. The first AI engine 125 is configured and trained to process the received communications to determine a subject matter of the received communications. In some embodiments, the first AI engine 125 is configured and trained to determine correlations between the subject matter of the received communications and the game play state data associated with the player's 102 current play of the video game. In some embodiments, the first AI engine 125 is configured to determine one or more of a tone, an emotion, and an emphasis associated with the subject matter of the received communications. In some embodiments, the first AI engine 125 is configured and trained to determine the manner and the timing for conveyance of the received communications to the player 102 of the video game based on one or more of the tone, the emotion, and the emphasis associated with the determined subject matter of the received communications.

Also, in some embodiments, the first AI engine 125 is configured and trained to determine whether the subject matter of the received communications is related to the player's 102 current play of the video game or to a real-world context separate from the player's 102 current play of the video game. In some embodiments, when the first AI engine 125 determines that the subject matter of the received communication is related to the player's 102 current play of the video game, the first AI engine 125 operates to determine the manner and timing for conveyance of the received communication to the player 102 of the video game based on the full context of the player's 102 current play of the video game, so as to minimize disruption of the player's 102 play of the video game. In some embodiments, when the first AI engine 125 determines that the subject matter of the received communication is related to a real-world context, the first AI engine 125 operates to determine the manner and timing for conveyance of the received communication to the player 102 of the video game based on the real-world context. In some embodiments, when the received communication is related to an urgent, important, and/or serious real-world context, the first AI engine 125 directs conveyance of the received communication to the player 102 of the video game in a manner that is intentionally disruptive of the player's 102 current play of the video game, so as to get the player's 102 immediate attention. In some embodiments, when the received communication is related to a real-world context of lower urgency, importance, and/or seriousness, the first AI engine 125 directs conveyance of the received communication to the player 102 of the video game in a manner that is coherent with the full context of the player's 102 current play of the video game, so as to minimize disruption of the player's 102 play of the video game.

In some embodiments, the first AI engine 125 is configured to convey received communications to the player 102 in a manner that minimizes distraction of the player 102 from their play of the video game. In some embodiments, the system 124 buffers (holds) received communications that are directed to the player 102 within the computer memory 113 until a time within the player's 102 play of the video game at which conveyance of the buffered received communication will be minimally distracting to the player's 102 play of the video game. By way of the first AI engine 125, the system 124 understands the context of the video game and the player's 102 current and upcoming play of the video game to identify optimal times for conveying buffered received communications to the player 102 during their play of the video game. In some embodiments, the first AI engine 125 is configured and trained to automatically evaluate, in real-time, the context of the player's 102 current play of the video game in conjunction with the dynamic aspects of the video game to determine appropriate and optimal buffering levels for the received communications at a given time and to determine appropriate and optimal times and mechanisms for conveying received communications to the player 102.

In some embodiments, the received communications from the external communication sources 109-1 to 109-N are represented in a style and manner that is commensurate with the current context of the player's 102 video game play. In some embodiments, the system 124 operates to convey the received communications to the player 102 in a manner that blends into the subject matter context, visual context, and audio context of the player's 102 current state in their play of the video game.

In some embodiments, the first AI engine 125 is configured to collectively process multiple received communications that are stored in the computer memory 113 to identify redundant communications and generate a consolidated communication for conveyance to the player 102 of the video game in lieu of the redundant communications. In some embodiments, the first AI engine 125 is configured to determine a subject matter of the consolidated communication. In some embodiments, the first AI engine 125 is configured to process the current game play state data of the video game to determine a relevancy level of the subject matter of the consolidated communication to a current video game play context associated with the player 102 of the video game. The first AI engine 125 is configured to determine a manner and a timing for conveyance of the consolidated communication to the player 102 of the video game based on the determined relevancy level of the subject matter of the consolidated communication to a current video game play context associated with the player 102 of the video game.

In some embodiments, the system 124 is configured to identify redundancy within the buffered received communications and to consolidate (synthesize) redundant buffered received communications for conveyance to the player 102 of the video game, so that the player 102 will not receive multiple duplicative communications from the one or more external communication sources 109-1 to 109-N. In some embodiments, the first AI engine 125 is configured and trained to identify redundancies across the communications received from the external communication sources 109-1 to 109-N, and generate a consolidated communication for conveyance to the player 102 instead of the redundant communications. In some embodiments, the redundancy and consolidation of duplicate/similar external communications is done over a specified period of time (in a moving temporal windowed manner) to ensure that external communications that are identified as duplicative and/or sufficiently similar are related to a same context within the video game corresponding to the player's 102 current play of the video game. This ensures that similar received communications that are applicable to different contexts within the video game are not consolidated by the system 124 for conveyance to the player 102. In some embodiments, multiple ones of the communication sources 109-1 to 109-N are joined into a group by the system 124, so that the communications received from the multiple ones of the communication sources 109-1 to 109-N are collectively processed by the first AI engine 125 for determination of redundancy and communication consolidation.

In some embodiments, the first AI engine 125 is configured to compress and/or represent an incoming communication, or a consolidation of multiple incoming communications, into a format that is appropriate for the current context within the video game corresponding to the player's 102 current play of the video game. For example, in some embodiments, if an incoming communication is rambling and long-winded, the first AI engine 125 is configured and trained to generate a more concise substitute communication for conveyance to the player 102 in lieu of the rambling/long-winded incoming communication.

In some embodiments, in determining the timing for conveyance of the received communication to the player 102 of the video game who is currently playing the video game, the first AI engine 125 functions to minimize disruption of the player's 102 play of the video game caused by the communication conveyance and/or to prioritize received communications for conveyance based on urgency and/or relevancy to a context of the player's 102 play of the video game. In some embodiments, the first AI engine 125 is configured to evaluate the player's 102 current context within the video game to determine how best to convey the received communication to the player 102. For example, if the player 102 is hiding from a monster in a closet within the context of the video game, the first AI engine 125 operates to direct audible conveyance of the received communication to the player 102 in a whispered tone, such as through an non-player character of a stuffed animal in the closet within the context of the video game. In some embodiments, the manner of conveyance of the received communications and/or consolidated communications to the player 102, as directed by the first AI engine 125, is one or more audible, textual, and graphical.

In some embodiments, the first AI engine 125 is configured to determine an urgency of the received communication based on the subject matter of the received communication. For example, if the first AI engine 125 determines that the subject matter of the received communication is a detection of smoke in the player's 102 house in the real-world, a highest level of urgency is determined for the received communication. In another example, if the first AI engine 125 determines that the subject matter of the received communication is an irrelevant comment from a spectator of the video game, a lowest level of urgency is determined for the received communication. It should be appreciated that the level of urgency that is determined by the first AI engine 125 for a given received communication is based on the training of the first AI engine 125, which includes some data indicative of confirmed/verified urgency levels of various incoming communications. In some embodiments, the first AI engine 125 is configured to process current game play state data of the video game to determine a relevancy level of the subject matter of the received communication to a current video game play context associated with the player 102 of the video game, where the manner and the timing for conveyance of the received communication to the player 102 of the video game, as determined by the first AI engine 125, is based on the relevancy level.

Some communications received from the external communication sources 109-1 to 109-N have particular urgency and relevancy within the video game context and are buffered and conveyed in accordance with their urgency and relevance as determined by the first AI engine 125. Also, some of the received communications have particular urgency and relevancy with the real-world external to the video game context. The received communications that concern real-world information are also buffered and conveyed in accordance with their urgency and relevance as determined by the first AI engine 125. In some embodiments, the first AI engine 125 is configured to prioritize conveyance of multiple incoming communications to the player 102. For example, in some embodiments, the first AI engine is configured to determine which of the external communications sources 109-1 to 109-N have more significance (higher priority) to the player 102 of the video game. In some cases, the first AI engine 125 learns the significance of various external communication sources 109-1 to 109-N through processing of prior game play state data in which the player 102 has received and responded to various communications received by the system 124 from the external communication sources 109-1 to 109-N. In some cases, the AI system learns the significance of various ones of the external communication sources 109-1 to 109-N based on the meaning/information that is conveyed in the communications that are received from the various external communication sources 109-1 to 109-N.

In some embodiments, prioritization of received communications for conveyance to the player 102 is based in part of a frequency at which communications are received from the various ones of the external communication sources 109-1 to 109-N. For example, in some embodiments, a communication received by the system 124 from a particular external communication source 109-x, where x is any integer from 1 to N, that provides infrequent communication may be elevated in priority for conveyance to the player 102. Also, in some embodiments, the first AI engine 125 prioritizes received communications based on their relevance to the player's 102 status (or potential status) within the current (or upcoming) context of the player's 102 video game play. For example, if a received communication includes subject matter that is potentially beneficial to the player's 102 play of the video game, the first AI engine recognizes the potential benefit and correspondingly elevates the priority of the received communication for conveyance to the player 102 of the video game.

The system 124 also includes a second AI engine 126 that is configured to implement a non-player character within the video game through which the received communication is conveyed. More specifically, the system 124 is configured to use the non-player character that is implemented by the second AI engine 126 to deliver the received communication (or a consolidation of multiple received communications) to the player 102 of the video game within a context of the player's 102 current play of the video game. The computer processor 119 is configured to direct conveyance of the received communication to the player 102 of the video game by way of the non-player character in accordance with the manner and the timing as determined by the first AI engine 125. The first AI engine 125 is connected to transmit data to the second AI engine 126, as indicated by arrow 127. Also, the second AI engine 126 is connected to transmit data to the first AI engine 125, as indicated by arrow 128. In various embodiments, the second AI engine 126 is configured to implement the non-player character based on the subject matter and the urgency of the received communication as determined by the first AI engine 125. The second AI engine 126 implements the non-player character within the video game to convey authorized communications to the player 102 of the video game, such that the player 102 receives the authorized communications in a non-distracting and clear manner, with minimal disruption of the normal contextual flow/activity of the video game.

In some embodiments, the non-player character that is implemented by the second AI engine 126 to convey the received communication(s) and/or the consolidated communication(s) to the player 102 is a non-player character that already exists within the context of the video game that is associated with the player's 102 current play of the video game. In some embodiments, the non-player character that is implemented by the second AI engine 126 to convey the received communication(s) and/or the consolidated communication(s) to the player 102 is from a population of non-player characters normally present within a context of the video game. In some embodiments, the extant non-player character that is implemented by the second AI engine 126 to convey the received communication(s) and/or the consolidated communication(s) to the player 102 is selected by the second AI engine 126 based on a relevance of appearance and/or mannerism of the extant non-player character to the tone, emotion, urgency, and/or other characterizing parameter of the subject matter of the received/consolidated communication(s) that is to be conveyed to the player 102, as determined by the first AI engine 125.

In some embodiments, the non-player character that is implemented by the second AI engine 126 to convey the received communication(s) and/or the consolidated communication(s) to the player 102 is a non-player character that does not already exist within the context of the video game that is associated with the player's 102 current play of the video game. In some embodiments, the second AI engine 126 generates a new non-player character for conveyance of the received communication(s) and/or the consolidated communication(s) to the player 102 within the context of the video game that is associated with the player's 102 current play of the video game. In some embodiments, the new non-player character that is generated by the second AI engine 126 to convey a particular received/consolidated communication(s) is representative of the external communication source 109-1 to 109-N from which the particular received/consolidated communication(s) originates. For example, in some embodiments, the new non-player character that is generated by the second AI engine 126 to convey a particular received/consolidated communication(s) is visibly, audibly, and/or linguistically representative of the external communication source 109-1 to 109-N from which the particular received/consolidated communication(s) originates. In some embodiments, the second AI engine 126 conveys a particular received/consolidated communication(s) to the player 102 through a non-player character within the video game that has speech characteristics that are similar to the real-world communication source 109-x from which the particular received/consolidated communication(s) originates. For example, in some embodiments, a non-player character implemented by the second AI engine 126 to convey a communication received from a friend of the player 102 is made to sound like the friend of the player 102. Also, in various embodiments, the manner in which the non-player character is implemented by the second AI engine 126 to convey the received communication is reflective of the tone, emotion, urgency, and/or other characterizing parameter of the received communication.

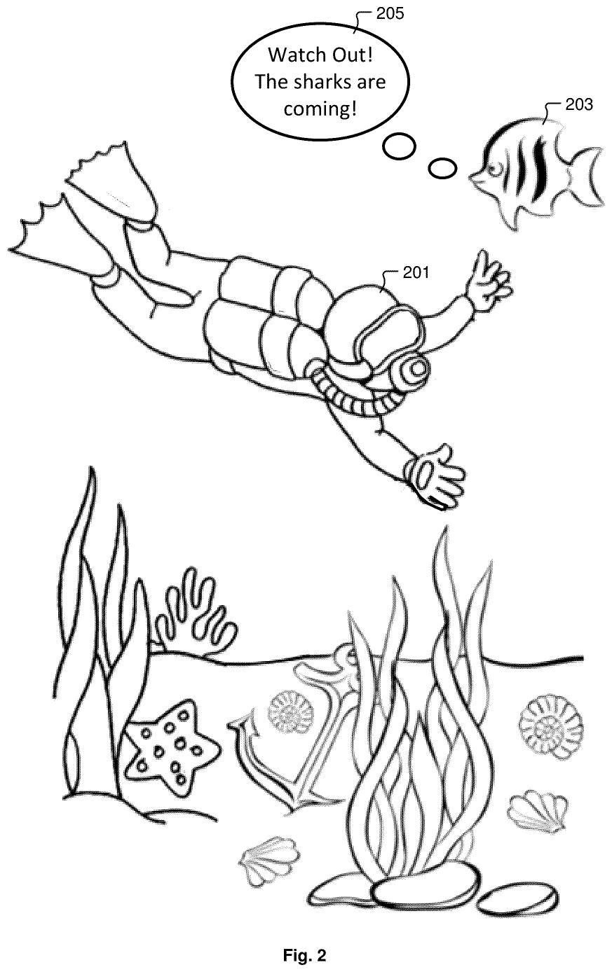

FIG. 2 shows an example of the second AI engine 126 implementing a non-player character 203 that already exists within the context of the player's 102 play of the video game in order to convey a received/consolidated communication 205 to the player 102, in accordance with some embodiments. An avatar 201 of the player 102 is also shown within the context of the video game. In this particular example, the communication received from the external communication source 109-x that is conveyed through the extant non-player character 203 is relevant and timely to the player's 102 play of the video game. It should be understood that the context of the video game, the subject matter of the received external communication, and the particular non-player character used to convey the received external communication are essentially limitless.

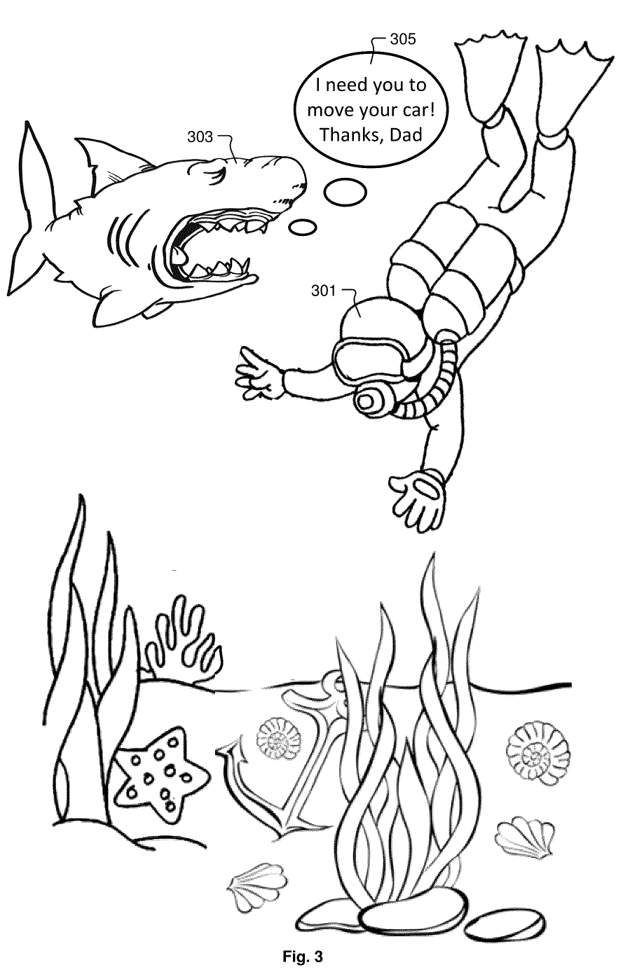

FIG. 3 shows an example of the second AI engine 126 implementing a non-player character 303 that already exists within the context of the player's 102 play of the video game in order to convey a received/consolidated communication 305 to the player 102, in accordance with some embodiments. An avatar 301 of the player 102 is also shown within the context of the video game. In this particular example, the communication received from the external communication source 109-x that is conveyed through the extant non-player character 303 is relevant to a real-world concern of the player 102. Also, in this particular example, the extant non-player character 303 is implemented by the second AI engine 126 in a manner that reflects the subject matter and tone of the received communication.

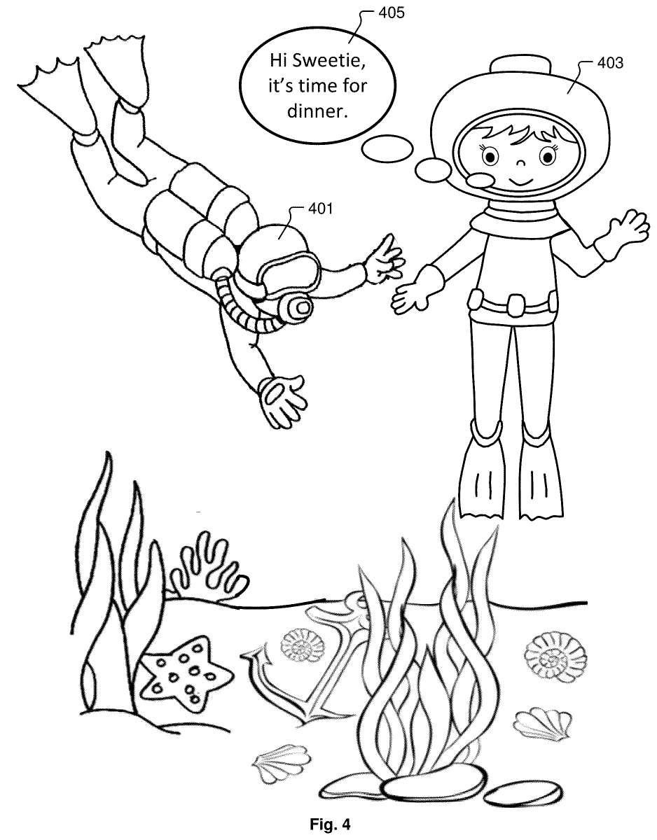

FIG. 4 shows another example of the second AI engine 126 implementing a non-player character 403 that does not already exist within the context of the player's 102 play of the video game in order to convey a received/consolidated communication 405 to the player 102, in accordance with some embodiments. An avatar 401 of the player 102 is also shown within the context of the video game. In this particular example, the communication received from the external communication source 109-x that is conveyed through the newly generated non-player character 403 is relevant to a real-world concern of the player 102. Also, in this particular example, the non-player character 403 is generated by the second AI engine 126 to resemble the real-world external communication source 109-x (e.g., person) of the received communication. Also, in this particular example, the non-player character 403 is generated by the second AI engine 126 to reflect the subject matter and tone of the received communication. It should be understood that the manner in which non-player characters can be generated by the second AI engine 126 to convey communications received from the external communication sources 109-1 to 109-N is essentially limitless.

It should be appreciated that the system 124 improves the player's 102 game play experience by reducing distractions caused by incoming communications from the external communication sources 109-1 to 109-N. Also, the system 124 improves the player's 102 game play experience by conveying received communications to the player 102 in a manner that is coherent with the context of the video game that is associated with the player's 102 current play of the video game. The system 124 also improves the player's 102 game play experience by improving the quality and clarity of communication to the player 102. The system 124 also improves the operation of the server device 112 by decreasing unnecessary expenditure of processing resources that would otherwise be required to convey redundant and/or sufficiently similar communications to the player 102 during play of the video game.

It should be appreciated that the system 124 is advantageously applicable to a limitless number of practical applications in which an external communication needs to be conveyed to a player of a video game. For example, the system 124 is particularly useful in conveying communications from spectators of the video game to the player 102 who is currently playing the video game. Also, the system 124 is particularly useful in conveying communications about real-world matters to the player 102 who is currently playing the video game in a manner that is minimally disruptive to the player's 102 play of the video game. It should be understood that the various embodiments disclosed herein are just a few of a limitless number of practical applications of the system 124 for automatically supporting conveyance of externally sourced communications to the player 102 of the video game during video game play.

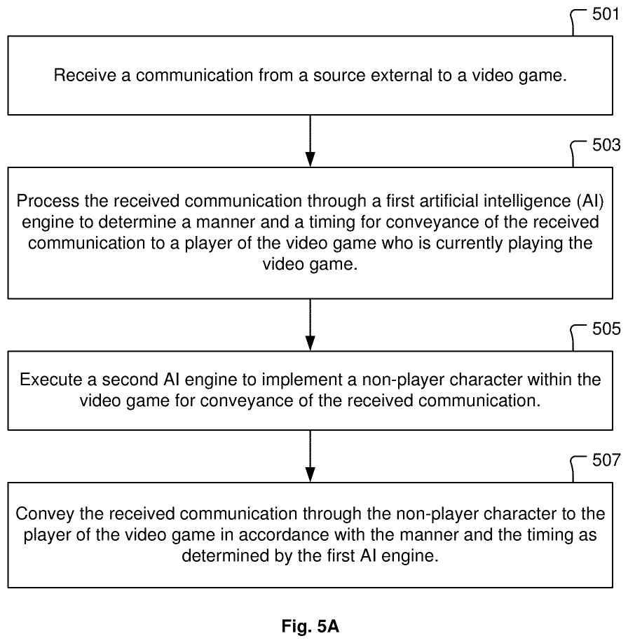

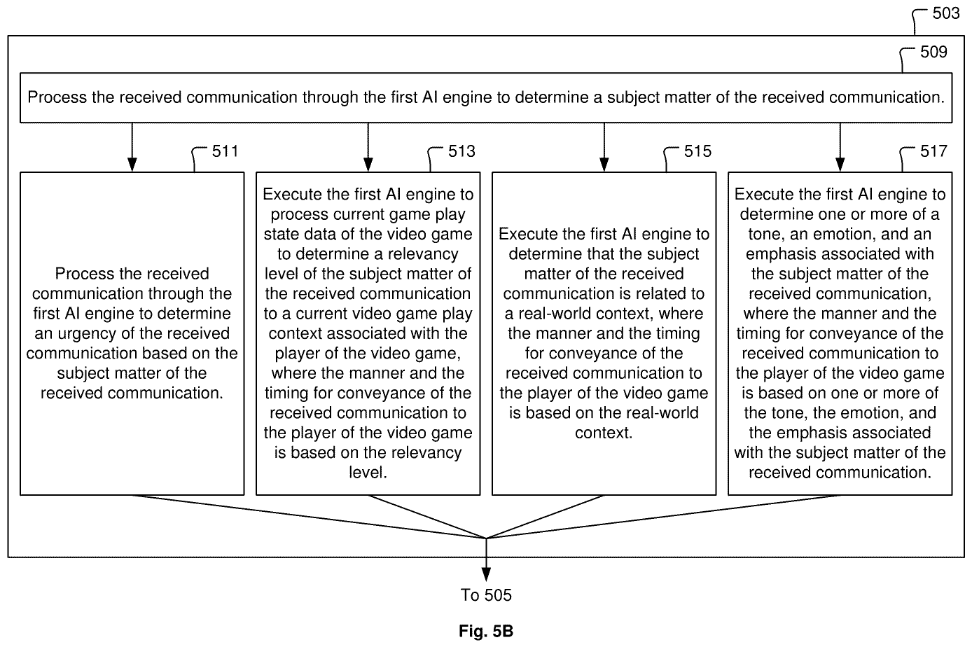

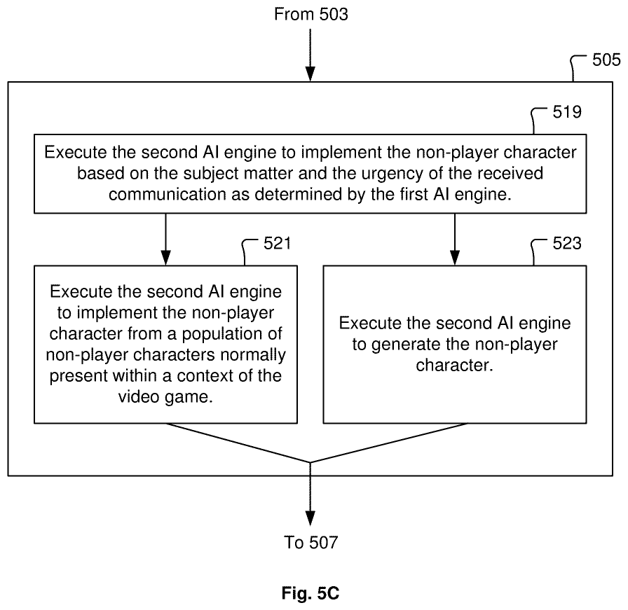

FIG. 5A shows a flowchart of a method for processing external communications in a video game, in accordance with some embodiments. The method includes an operation 501 for receiving a communication from a source external to a video game. The method also includes an operation 503 for processing the received communication through the first AI engine 125 to determine a manner and a timing for conveyance of the received communication to the player 102 of the video game who is currently playing the video game. The method also includes an operation 505 for executing the second AI engine 126 to implement a non-player character within the video game for conveyance of the received communication. The method also includes an operation 507 for conveying the received communication through the non-player character to the player 102 of the video game in accordance with the manner and the timing as determined by the first AI engine 125.

FIG. 5B shows a more detailed flowchart of the operation 503 of the method of FIG. 5A for processing external communications in the video game, in accordance with some embodiments. The method includes an operation 509 for processing the received communication through the first AI engine 125 to determine a subject matter of the received communication. The method also includes an operation 511 for processing the received communication through the first AI engine 125 to determine an urgency of the received communication based on the subject matter of the received communication. The method also includes an operation 513 for executing the first AI engine 125 to process current game play state data of the video game to determine a relevancy level of the subject matter of the received communication to a current video game play context associated with the player 102 of the video game, where the manner and the timing for conveyance of the received communication to the player 102 of the video game is based on the relevancy level. The method also includes an operation 515 for executing the first AI engine 125 to determine that the subject matter of the received communication is related to a real-world context, where the manner and the timing for conveyance of the received communication to the player 102 of the video game is based on the real-world context. The method also includes an operation 517 for executing the first AI engine 125 to determine one or more of a tone, an emotion, and an emphasis associated with the subject matter of the received communication, where the manner and the timing for conveyance of the received communication to the player 102 of the video game is based on one or more of the tone, the emotion, and the emphasis associated with the subject matter of the received communication.

FIG. 5C shows a more detailed flowchart of the operation 505 of the method of FIG. 5A for processing external communications in the video game, in accordance with some embodiments. The method includes an operation 519 for executing the second AI engine 126 to implement the non-player character based on the subject matter and the urgency of the received communication as determined by the first AI engine 125. The method also includes an operation 521 for executing the second AI engine 126 to implement the non-player character from a population of non-player characters normally present within a context of the video game. The method also includes an operation 523 for executing the second AI engine 126 to generate the non-player character.

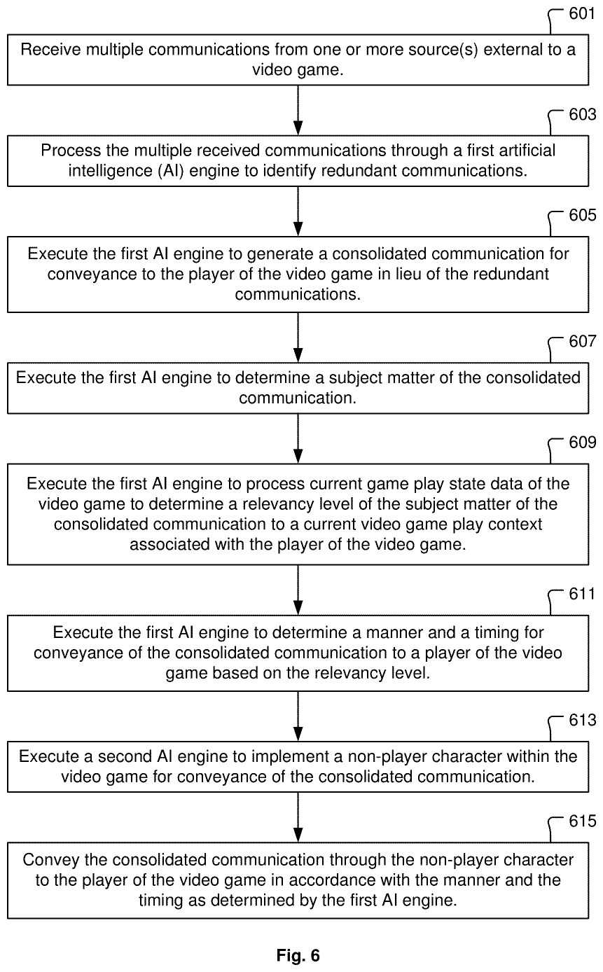

FIG. 6 shows a flowchart of a method for processing external communications in a video game, in accordance with some embodiments. The method includes an operation 601 for receiving multiple communications from one or more source(s) external to a video game. The method also includes an operation 603 for executing the first AI engine 125 to collectively process multiple received communications to identify redundant communications. The method includes an operation 605 for executing the first AI engine 125 to generate a consolidated communication for conveyance to the player 102 of the video game in lieu of the redundant communications. The method includes an operation 607 for executing the first AI engine 125 to determine a subject matter of the consolidated communication. The method includes an operation 609 for executing the first AI engine 125 to process current game play state data of the video game to determine a relevancy level of the subject matter of the consolidated communication to a current video game play context associated with the player 102 of the video game. The method includes an operation 611 for executing the first AI engine 125 to determine a manner and a timing for conveyance of the consolidated communication to the player 102 of the video game based on the relevancy level. The method includes an operation 613 for executing the second AI engine 126 to implement a non-player character within the video game for conveyance of the consolidated communication. The method includes an operation 615 for conveying the consolidated communication through the non-player character to the player 102 of the video game in accordance with the manner and the timing as determined by the first AI engine 125.

Implementations of the present disclosure for the system 124 and methods for processing external communications in a video game may be practiced using various computer device configurations including hand-held devices, microprocessor systems, microprocessor-based or programmable consumer electronics, minicomputers, mainframe computers, head-mounted display, wearable computing devices and the like. Embodiments of the present disclosure can also be practiced in distributed computing environments where tasks are performed by remote processing devices that are linked through a wire-based or wireless network.

With the above embodiments in mind, it should be understood that the disclosure can employ various computer-implemented operations involving data stored in computer systems. These operations are those requiring physical manipulation of physical quantities. Any of the operations described herein that form part of the disclosure are useful machine operations. The disclosure also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although various method operations were described in a particular order, it should be understood that other housekeeping operations may be performed in between the method operations. Also, method operations may be adjusted so that they occur at slightly different times or in parallel with each other. Also, method operations may be distributed in a system which allows the occurrence of the processing operations at various intervals associated with the processing.

One or more embodiments can also be fabricated as computer readable code (program instructions) on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices, or any other type of device that is capable of storing digital data. The computer readable medium can include computer readable tangible medium distributed over a network-coupled computer system so that the computer readable code is stored and executed in a distributed fashion.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

What is claimed is:

1. A system for processing external communications in a video game, comprising:
a computer processor configured to receive a communication from a source external to a video game;
a computer memory configured to store the received communication;
a first artificial intelligence (AI) engine configured to process the received communication stored in the computer memory to determine a manner and a timing for conveyance of the received communication to a player of the video game who is currently playing the video game; and
a second AI engine configured to implement a non-player character within the video game through which the received communication is conveyed, the computer processor configured to direct conveyance of the received communication to the player of the video game by way of the non-player character in accordance with the manner and the timing as determined by the first AI engine.

2. The system as recited in claim 1, wherein the first AI engine is configured to determine a subject matter of the received communication.

3. The system as recited in claim 2, wherein the first AI engine is configured to determine an urgency of the received communication based on the subject matter of the received communication.

4. The system as recited in claim 3, wherein the second AI engine is configured to implement the non-player character based on the subject matter and the urgency of the received communication as determined by the first AI engine.

5. The system as recited in claim 4, wherein the non-player character is from a population of non-player characters normally present within a context of the video game.

6. The system as recited in claim 4, wherein the non-player character is generated by the second AI engine.

7. The system as recited in claim 2, wherein the first AI engine is configured to process current game play state data of the video game to determine a relevancy level of the subject matter of the received communication to a current video game play context associated with the player of the video game, wherein the manner and the timing for conveyance of the received communication to the player of the video game is based on the relevancy level.

8. The system as recited in claim 2, wherein the first AI engine is configured to determine that the subject matter of the received communication is related to a real-world context, wherein the manner and the timing for conveyance of the received communication to the player of the video game is based on the real-world context.

9. The system as recited in claim 2, wherein the first AI engine is configured to determine one or more of a tone, an emotion, and an emphasis associated with the subject matter of the received communication, wherein the manner and the timing for conveyance of the received communication to the player of the video game is based on one or more of the tone, the emotion, and the emphasis associated with the subject matter of the received communication.

10. The system as recited in claim 1, wherein the first AI engine is configured to collectively process multiple received communications stored in the computer memory to identify redundant communications and generate a consolidated communication for conveyance to the player of the video game in lieu of the redundant communications.

11. The system as recited in claim 10, wherein the first AI engine is configured to determine a subject matter of the consolidated communication, wherein the first AI engine is configured to process current game play state data of the video game to determine a relevancy level of the subject matter of the consolidated communication to a current video game play context associated with the player of the video game, wherein a manner and a timing for conveyance of the consolidated communication to the player of the video game is based on the relevancy level.

12. A method for processing external communications in a video game, comprising:
receiving a communication from a source external to a video game;
processing the received communication through a first artificial intelligence (AI) engine to determine a manner and a timing for conveyance of the received communication to a player of the video game who is currently playing the video game;
executing a second AI engine to implement a non-player character within the video game for conveyance of the received communication; and
conveying the received communication through the non-player character to the player of the video game in accordance with the manner and the timing as determined by the first AI engine.

13. The method as recited in claim 12, further comprising:
processing the received communication through the first AI engine to determine a subject matter of the received communication.

14. The method as recited in claim 13, further comprising:
processing the received communication through the first AI engine to determine an urgency of the received communication based on the subject matter of the received communication.

15. The method as recited in claim 14, wherein the second AI engine implements the non-player character based on the subject matter and the urgency of the received communication as determined by the first AI engine.

16. The method as recited in claim 15, wherein the non-player character is from a population of non-player characters normally present within a context of the video game.

17. The method as recited in claim 15, wherein the non-player character is generated by the second AI engine.

18. The method as recited in claim 13, further comprising:
executing the first AI engine to process current game play state data of the video game to determine a relevancy level of the subject matter of the received communication to a current video game play context associated with the player of the video game, wherein the manner and the timing for conveyance of the received communication to the player of the video game is based on the relevancy level.

19. The method as recited in claim 13, further comprising:
executing the first AI engine to determine that the subject matter of the received communication is related to a real-world context, wherein the manner and the timing for conveyance of the received communication to the player of the video game is based on the real-world context.

20. The method as recited in claim 13, further comprising:
executing the first AI engine to determine one or more of a tone, an emotion, and an emphasis associated with the subject matter of the received communication, wherein the manner and the timing for conveyance of the received communication to the player of the video game is based on one or more of the tone, the emotion, and the emphasis associated with the subject matter of the received communication.

21. The method as recited in claim 12, further comprising:
executing the first AI engine to collectively process multiple received communications to identify redundant communications; and
executing the first AI engine to generate a consolidated communication for conveyance to the player of the video game in lieu of the redundant communications.

22. The method as recited in claim 21, further comprising:
executing the first AI engine to determine a subject matter of the consolidated communication;
executing the first AI engine to process current game play state data of the video game to determine a relevancy level of the subject matter of the consolidated communication to a current video game play context associated with the player of the video game; and
executing the first AI engine to determine a manner and a timing for conveyance of the consolidated communication to the player of the video game based on the relevancy level.
